(19) United States
(12) Patent Application Publication
(10) Pub. No.: US 2015/0157425 A1
(43) Pub. Date: Jun. 11, 2015

(54) SERRATED DENTAL IMPLANT

(71) Applicant: A.B. Dental Devices Ltd., Nir Galim (IL)

(72) Inventor: Eliezer Bar Shalom, Nir-Galim (IL)

(21) Appl. No.: 14/404,070

(22) PCT Filed: May 21, 2013
(86) PCT No.: PCT/IL2013/050430

§ 371 Date: Nov. 26, 2014

(30) Foreign Application Priority Data
May 29, 2012 (IL) 12169718.9

(51) Int. Cl. A61C 8/00; A61C 13/00

(52) U.S. Cl. CPC A61C 8/0024; A61C 8/0025; A61C 8/0037; A61C 13/0018; A61C 2008/0046

(57) ABSTRACT

A dental implant having a serrated outer thread and body threads, optionally serrated in the opposite direction to outer thread. The serration of outer thread improves the penetration of implant into the jawbone, while body threads improve the anchoring of implant within the jaw bone.

### BACKGROUND

1. Technical Field

The present invention relates to the field of dentistry, and more particularly, to a dental implant.

2. Discussion of Related Art

The following documents illustrate various prior art dental implants, in which the outer thread is serrated in order to increase the surface area of the thread and stabilize implant in the bone: U.S. Pat. No. 7,273,373, U.S. Pat. No. 6,679,701, U.S. Pat. No. 6,386,877, U.S. Pat. No. 5,110,245, WO2011039162, WO2007074498 and JP8019555 disclose variants of a uniform horizontal serration, which differ in the exact form of the saw-teeth formed on the outer thread.

Korean Patent Document No. 100912272, which is incorporated herein by reference in its entirety, teaches ceramic dental implants which increase coherence with an alveolar bone by increasing the surface area of the implant fixture using large and small elements of various forms which are parallel to each other and radial with respect to the implants.

### BRIEF SUMMARY

One aspect of the present invention provides a dental implant comprising (i) an outer thread that is serrated to have saw-teeth, each saw-tooth having a vertical inclination in a proximal-distal direction, an extent in a radial direction in respect to an axis of the implant, and a horizontal inclination tangential to a radius extending from the axis of the implant, and (ii) at least one body thread on a body of the implant that winds parallel to the outer thread.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1, 2A, 2B and 3 are schematic illustrations of a dental implant according to some embodiments of the invention,

FIG. 4 is a high level flowchart illustrating a method of producing or designing a dental implant, to some embodiments of the invention, and

FIGS. 5A-5F, 6A and 6B are schematic illustrations of a dental implant according to some embodiments of the invention.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

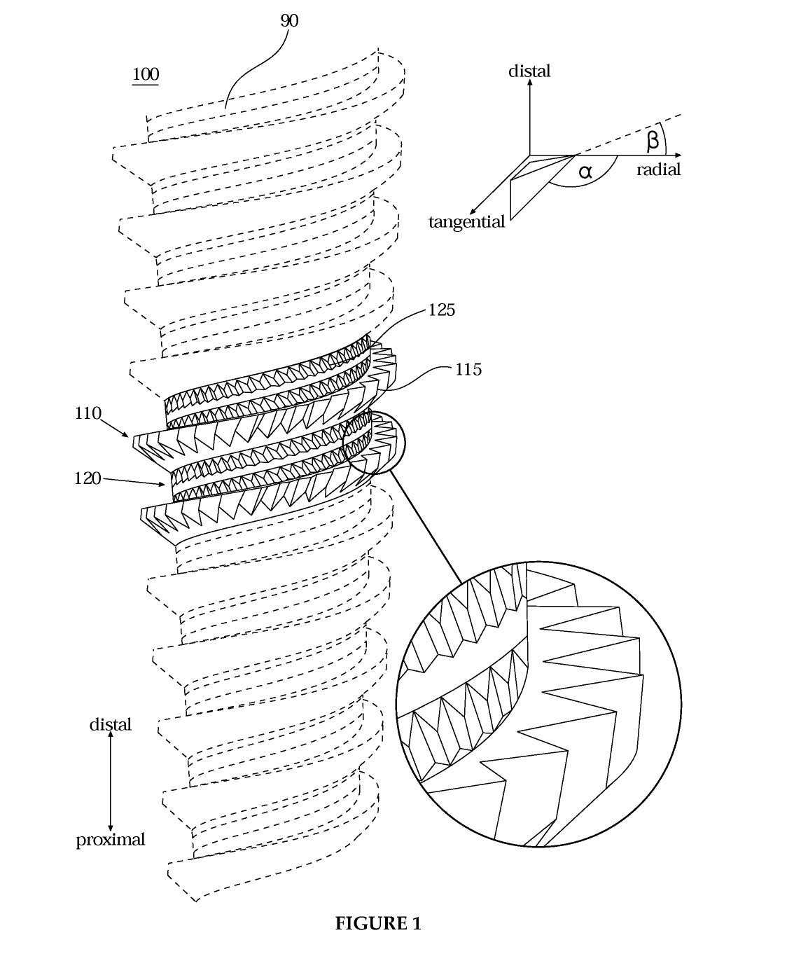

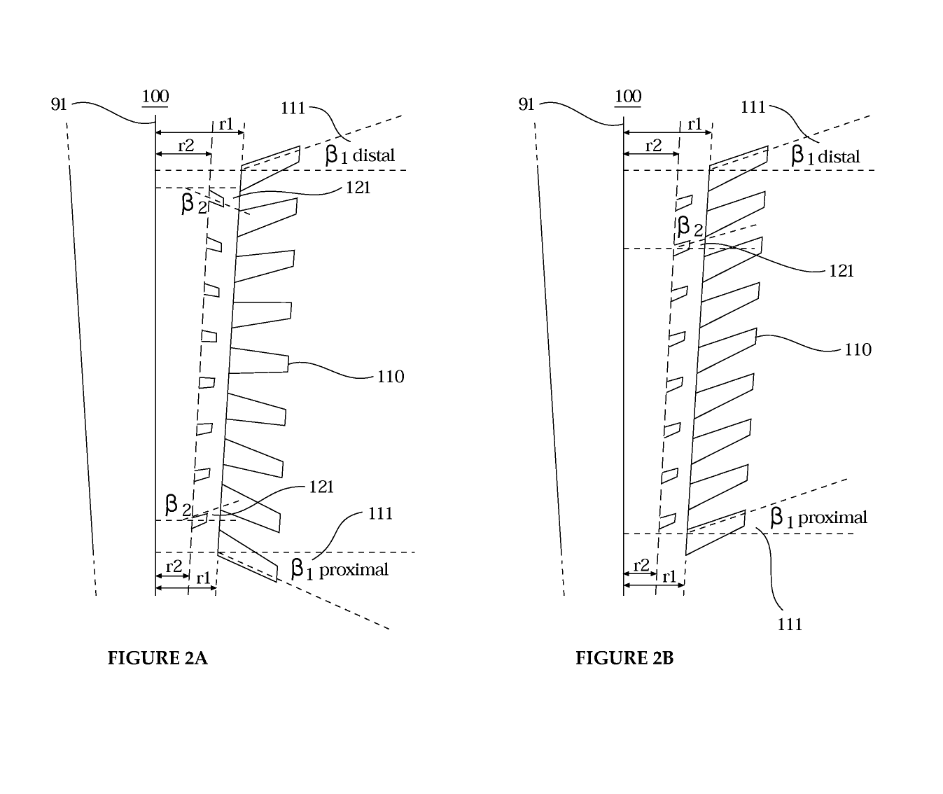

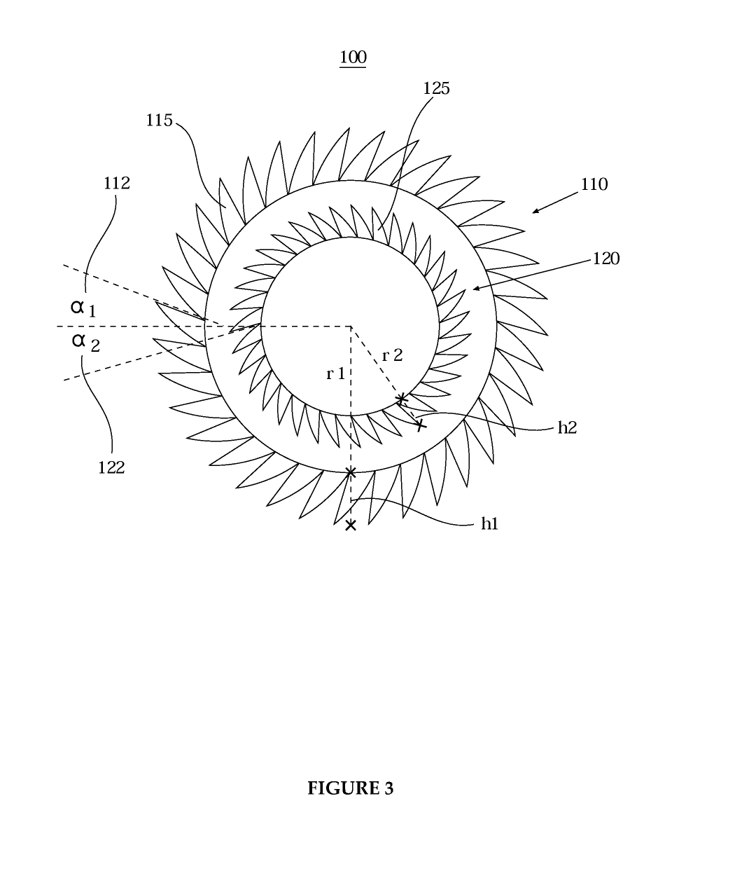

FIGS. 1, 2A, 2B and C are schematic illustrations of a dental implant 100 according to some embodiments of the invention. Dental implant 100 has a serrated outer thread 110 and body threads 120 serrated in the opposite direction to outer thread 110. The serration of outer thread 110 improves the penetration of implant 100 into the jawbone, while body threads 120 improve the anchoring of implant 100 within the jaw bone. The insets in FIG. 1 illustrate the spatial relations of the saw-teeth 115 and 125. FIGS. 2A and 2B are high level schematic illustrations of a longitudinal section through implant 100, illustrating schematically two possible configurations of serrated outer thread 110. FIG. 3 is a high level schematic illustration of a transverse section through implant 100, illustrating schematically the relative orientations of serrated outer thread 110 and serrated body thread 120.

Dental implant 100 comprises outer thread 110 that is serrated to have saw-teeth 115, each saw-tooth 115 having a vertical inclination β₁ 111 in a proximal-distal direction, an extent h₁ in a radial direction in respect to an axis 91 of implant 100, and a horizontal inclination α₁, 112 tangential to a radius r₁ extending from axis 91 of implant 100.

Dental implant 100 comprises at least one body thread 120 on a body 90 of implant 100 that winds parallel to outer thread 110, wherein at least one body thread 120 is serrated to have saw-teeth 125, each saw-tooth 125 having a vertical inclination β₂, 121 in a proximal-distal direction, an extent h₂ in a radial direction in respect to axis 91 of implant 100, and a horizontal inclination α₂, 122 tangential to a radius r₂ extending from axis 91 of implant 100.

Horizontal inclination 122 of the saw-teeth of the at least one body thread 120 is in an opposite direction in respect to the saw-teeth of the horizontal inclination 112 of the outer thread 110.

It is noted that the terms “distal” and “proximal” are used in the application with respect to the jaw into which the implant is implanted, as clearly indicated in FIG. 1 (the implant narrows toward the jaw). Correspondingly, the directions distally and proximally relate to the implant as a whole, as denoted in FIG. 1. The terms “steep” and “gradual” refer to the saw tooth profile, and the terms “internal thread” and the term “body thread” are used synonymously. Generally, the spatial terms used in the disclosure are defined with respect to the implant, and not with respect to single saw-teeth. In particular, the vertical axis is the proximal-distal axis of the implant. The horizontal plane is per definition perpendicular to the vertical axis and includes the radial direction and the tangential direction.

Implant 100 may be produced by laser sintering techniques to generate the intricate structure disclosed Implants with different spatial parameters may be designed and produced simultaneously by this technique.

Examples for possible embodiments of implant 100 may include the following.

Vertical inclination 111 (β₁) of outer saw-teeth 115 may be between 0° and 10° distad (i.e. in distal direction).

Vertical inclination 121 (β₂) of inner saw-teeth 125 may be around 0°, or a few degrees above or below the level.

Horizontal inclination 112 (α₁) of outer saw-teeth 115 may be between 0° and 10° clockwise from the radius (r₁).

Horizontal inclination 122 (α₂) of inner saw-teeth 125 may be between 0° and 5° counterclockwise from the radius (r₂).

Horizontal inclination 112 (60₁) of outer saw-teeth 115 may be clockwise from the radius (r₁) and horizontal inclination 122 (α₂) of inner saw-teeth 125 may be counterclockwise to the radius (r₂).

The extent (h₁) of outer saw-teeth 115 may be between 0.4 and 1 mm For example, for implants 100 having a diameter of 3.75 mm outer saw-teeth 115 may protrude by about 0.4 mm on each side, while in larger implants 100 having diameters between 4.5-6 outer saw-teeth 115 may protrude by up to 1 mm on each side. In embodiments, outer saw-teeth 115 may extend by 15-35% of the implant's radius (h₁=0.15 to 0.35 times r₁ (or times (r₁+h₁)).

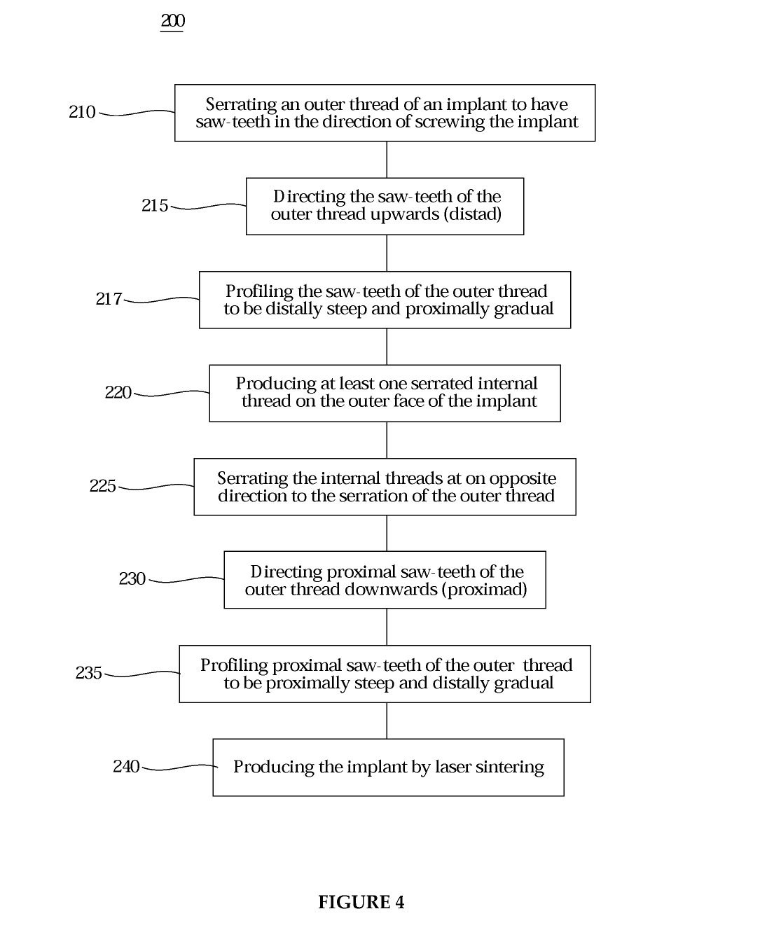

FIG. 4 is a high level flowchart illustrating a method 200 of producing or designing a dental implant, to some embodiments of the invention.

Method 200 comprises at least some of the following stage: serrating an outer thread of an implant to have saw-teeth at the direction of screwing the implant (stage 210), directing the saw-teeth of the outer thread upwards distad (stage 215), profiling the saw-teeth of the outer thread to be distally steep and proximally gradual (stage 217), producing at least one serrated internal thread on the outer face of the implant (stage 220), serrating the internal threads at an opposite direction to the serration of the outer thread (stage 225), for example, directing the outer saw-teeth clockwise and directing he inner saw-teeth counterclockwise, directing proximal saw-teeth of the outer thread downwards proximad (stage 230), and profiling proximal saw-teeth of the outer thread to be proximally steep and distally gradual (stage 235). Method 200 may be carried out by laser sintering (stage 240) to allow the exact production of the intricate structure. Method 200 may further comprise producing the dental implant to have a proximal cutting edge (at the bottom of the implant), possibly as a continuation of the outer thread and possibly serrated, to enhance the penetration of the implant into the jawbone.

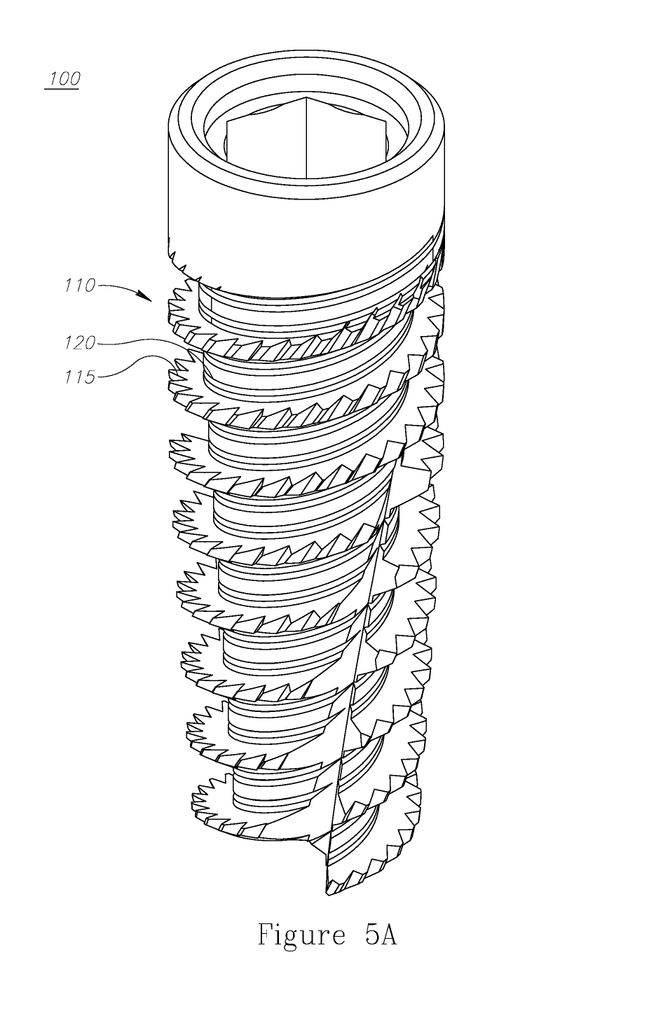

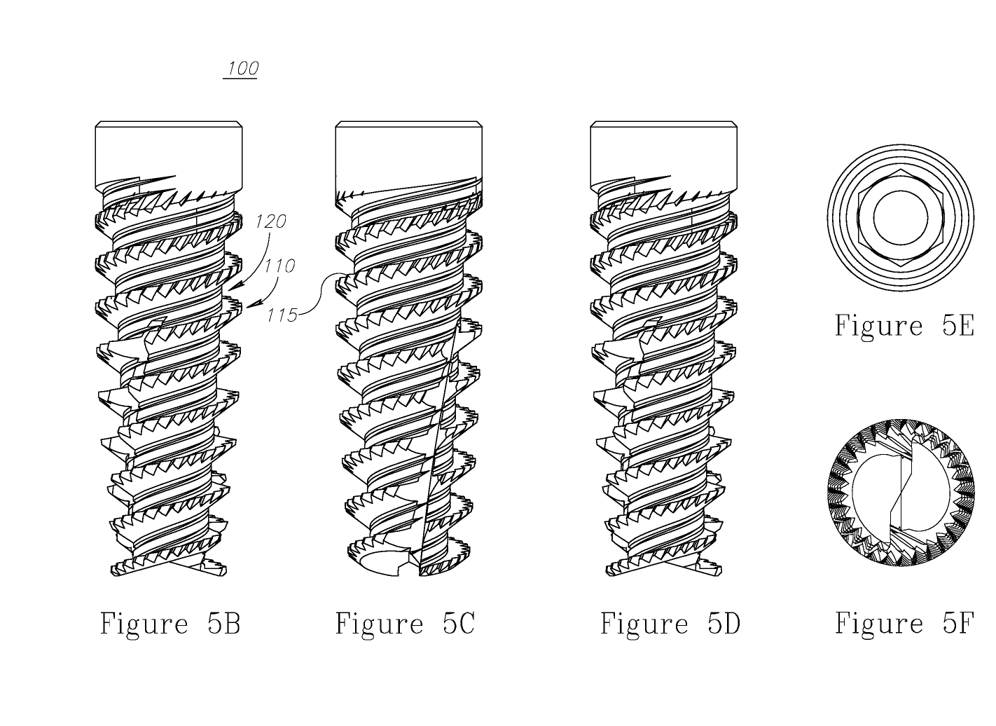

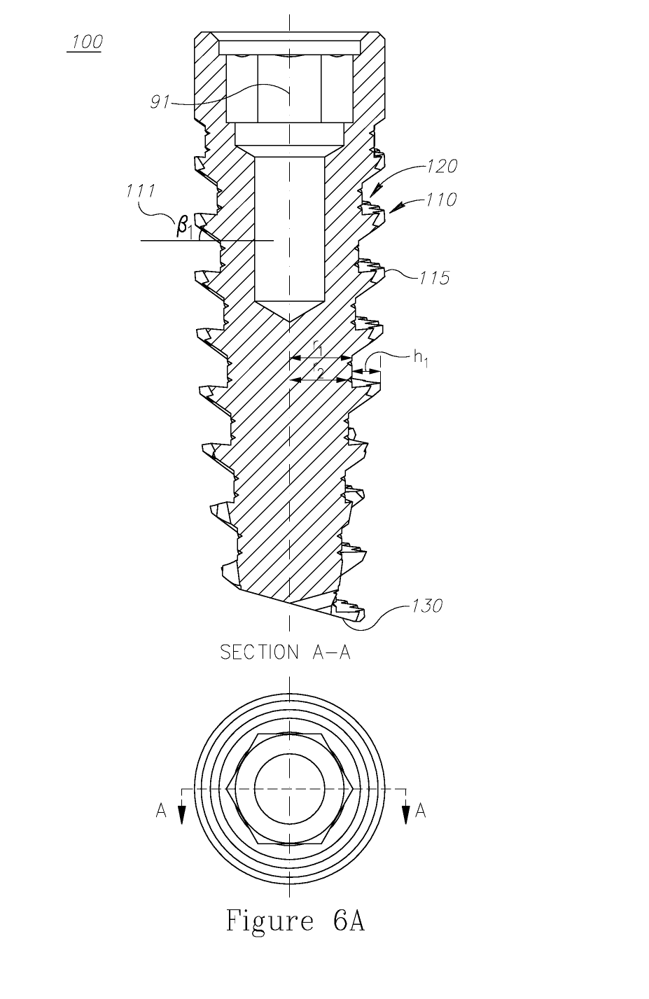

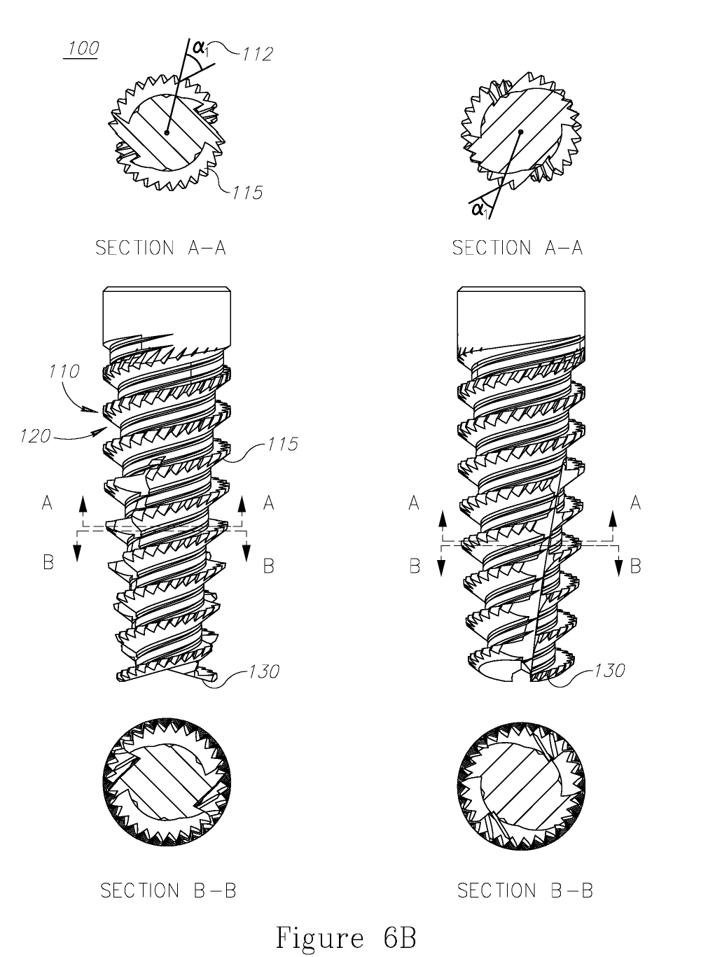

FIGS. 5A-5F, 6A and 6B are schematic illustrations of a dental implant according to some embodiments of the invention. FIG. 5A is a perspective view of dental implant 100, FIGS. 5B-5D are three side views of dental implant 100, FIGS. 5E and 5F are top and bottom views, respectively, of dental implant 100, FIG. 6A is a longitudinal cross section of dental implant 100 and FIG. 6B illustrates transversal cross sections at two levels of dental implant 100.

FIGS. 5A-5F, 6A and 6B illustrate implant 100 with serrated outer thread 110 having saw-teeth 115 which are inclined in a distal direction (β₁ 111, FIG. 6A) and in a tangential direction with respect to implant 100's radius (α₁ 112, FIG. 6B). In the illustrated embodiment, implant 100 comprises two body threads 120 between outer thread 110, and body threads 120 comprise an indentation which is small relative to serration 115 (r₂ is close to r₁, FIG. 6A). This is example is not limiting in that body threads 120 may be single or multiple, similar or varying from each other, and have a more significant depth and serration, as illustrated above.

FIGS. 5A-5F, 6A and 6B further illustrate implant 100 with a bottom (proximal) cutting edge 130, arranged to bore into the bone upon insertion and further improve the penetration of implant 100 into the jawbone. Cutting edge 130 may be a continuation of outer thread 110 and be likewise serrated. Saw teeth 115 may enhance the penetration efficiency of cutting edge 130. Size and declination of saw teeth 115 on cutting edge 130 may be designed to optimize the penetration efficiency of cutting edge 130.

Advantageously, the present invention increases the penetration capability of the implant through the bone, as well as anchoring it tighter into the bone. To accomplish this purpose, the saw teeth are not radial, but inclined in the horizontal surface and deviate from the radial direction. In embodiments, the large and small saw teeth have different purposes—the saw teeth of the outer thread enhance penetration of the implant into the bone, while the saw teeth of the body thread enhance the retention of the implant within the jaw.

Advantageously, in embodiments, the saw teeth of the outer thread and/or the saw teeth of the body thread have an asymmetric shape and exhibit a cutting edge., Embodiments of the invention may include a longitudinal variability in the vertical inclination of the saw teeth, to control the forces applied by the saw teeth on the jawbone during penetration and during anchoring of the implant in the jawbone.

Finally, basing, in embodiments, the saw teeth of the body thread on a more internal surface than the surface of the implant, may enhance the anchoring stability of the implant and may improve the boring efficiency of the implant by removing debris and fluids if such occur.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination.

Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claimed is:

1. A dental implant (100) comprising:
an outer thread (110) that is serrated to have saw-teeth (115), each saw-tooth (115) having a vertical inclination (111, β1) in a proximal-distal direction, an extent (h1) in a radial direction in respect to an axis (91) of the implant (100), and a horizontal inclination (112, α1) tangential to a radius (r1) extending from the axis (91) of the implant (100), and at least one body thread (120) on a body (90) of the implant (100) that winds parallel to the outer thread (110).

2. The dental implant of claim 1,
wherein the at least one body thread (120) is serrated to have saw-teeth (125), each saw-tooth (125) having a vertical inclination (121, β2) in a proximal-distal direction, an extent (h2) in a radial direction in respect to the axis (91) of the implant (100), and a horizontal inclination (122, α2) tangential to a radius (r2) extending from the axis (91) of the implant (100), and
wherein the horizontal inclination (122) of the saw-teeth of the at least one body thread (120) is in an opposite direction in respect to the saw-teeth of the horizontal inclination (112) of the outer thread (110).

3. The dental implant of claim 2, wherein the vertical inclination (121, β2) of the saw-teeth (125) of the body thread is substantially 0°.

4. The dental implant of claim 2, wherein the horizontal inclination (122, α2) of the saw-teeth (125) of the body thread is between 0° and 5° counterclockwise from the radius (r2).

5. The dental implant of claim 2, wherein the horizontal inclination (112, α1) of the saw-teeth (115) of the outer thread is clockwise from the radius (r1) and the horizontal inclination (122, α2) of the saw-teeth (125) of the body thread counterclockwise to the radius (r2).

6. The dental implant of claim 1, wherein the implant (100) is produced by laser sintering.

7. The dental implant of claim 1, wherein the vertical inclination (111, β1) of the saw-teeth (115) of the outer thread is between 0° and 10° distad.

8. The dental implant of claim 1, wherein the horizontal inclination (112, α1) of the saw-teeth (115) of the outer thread is between 0° and 10° clockwise from the radius (r1).

9. The dental implant of claim 1, wherein the extent (h1) of the saw-teeth (115) of the outer thread is between 0.4 and 1 mm

10. The dental implant of claim 1, further comprising a proximal cutting edge.

11. The dental implant of claim 10, wherein the cutting edge is a continuation of the serrated outer thread.

12. A method comprising
serrating an outer thread of an implant to have saw-teeth at the direction of screwing the implant,
directing the saw-teeth of the outer thread in a distal direction,
profiling the saw-teeth of the outer thread to be distally steep and proximally gradual,
producing at least one body thread on the outer face of the implant, and
profiling proximal saw-teeth of the outer thread to be proximally steep and distally gradual.

13. The method of claim 12, further comprising serrating the internal threads at an opposite direction to the serration of the outer thread, and

14. The method of claim 12, further comprising directing proximal saw-teeth of the outer thread in a proximal direction.

15. The method of claim 12, carried out by laser sintering.

16. The method of claim 12, wherein the saw-teeth of the outer thread are directed clockwise and the saw-teeth of the body thread are directed counterclockwise.

17. The method of claim 12, further comprising producing the dental implant to have a proximal cutting edge.
